(19) United States
(12) Patent Application Publication
(10) Pub. No.: US 2008/0291555 A1
(43) Pub. Date: Nov. 27, 2008

(54) OPTICAL ELEMENT HOLDING APPARATUS, BARREL, EXPOSURE APPARATUS AND DEVICE MANUFACTURING METHOD

(76) Inventor: Takaya OKADA, Kumagaya-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/126,621

(22) Filed: May 23, 2008

Related U.S. Application Data
(60) Provisional application No. 60/924,925, filed on Jun. 5, 2007.

(30) Foreign Application Priority Data
May 25, 2007 (JP) 2007-138913

(51) Int. Cl. G02B 7/02

(52) U.S. Cl. 359/820

(57) ABSTRACT

An optical element holding apparatus includes an aluminum buffer member accommodated in a stainless steel frame body and having a linear expansion coefficient differing from that of the frame body. The buffer member contacts a first member of a rotation link block. The frame body includes slits defining the rotation link block, a second connection block, a first connection block, and a displacement block. Drive force generated by expansion of the buffer member when the temperature changes is amplified by the rotation link block, the second connection block, the first connection block, and the displacement block and transmitted to the support member to move the support member toward the lens.

### CROSS-REFERENCE TO RELATED APPLICATIONS

This application claims the benefit of priority from prior Japanese Patent Application No. 2007-138913, filed on May 25, 2007, and U.S. Provisional Patent Application No. 60/924,925, filed on Jun. 5, 2007.

### BACKGROUND OF THE INVENTION

The present invention relates to an optical element holding apparatus for holding an optical element such as a lens and a mirror. The present invention also relates to a barrel that includes at least one optical element. The present invention further relates to an exposure apparatus used when manufacturing a device such as a semiconductor device, a liquid crystal display device, and a thin-film magnetic head, and to a device manufacturing method.

An optical system for this type of exposure apparatus includes optical elements such as a lens and a mirror. The optical elements are held via an optical element holding apparatus. In this type of exposure apparatus, each optical element may be distorted when assembling, storing, transporting, or operating the optical system due to temperature changes. Such distortion must be minimized.

In this regard, the optical systems of an exposure apparatus includes a projection optical system that includes optical elements (e.g., a lens) generally accommodated in a barrel by means of an optical element holding apparatus. This optical element holding apparatus includes a frame body, and the frame body is designed to prevent effects due to linear expansion coefficient differences between the lens and the frame body that occur when assembling or transporting the projection optical system.

Circuit patterns of semiconductor devices have become further miniaturized due to strict demands for higher integration. Thus, in a semiconductor device manufacturing exposure apparatus, it is required that the exposure accuracy be further improved and that the resolution be further increased. This has increased the significance of technology for maintaining an optical surface of an optical element in a satisfactory state.

As such an optical element holding apparatus that maintains an optical surface of an optical element in a satisfactory state, a holding apparatus including a cantilever bent portion that is formed in a lens cell has been proposed. For example, the holding apparatus has three seating positions, to which a lens is adhered, on the cantilever bent portion (see patent document 1). In this conventional structure, the cantilever bent portion absorbs expansion differences and contraction differences between the frame body and lens caused by temperature changes so that the lens is not distorted due to mechanical stress.
[Patent Document 1] U.S. Pat. No. 4,733,945

### SUMMARY OF THE INVENTION

In the holding apparatus of the prior art, the cantilever bent portion bends to absorb expansion and contraction differences between the frame body and lens. However, since the cantilever bent portion acts as a spring or a pivot, there is a problem in which the cantilever bent portion has a low vibration mode frequency.

For example, there is a problem in which the relative positions of the frame body and lens change when vibration of a movable member such as a motor or stage is transmitted to the cantilever bent portion.

It is an object of the present invention to provide an optical element holding apparatus and a barrel for reducing distortion of an optical element that would be caused by differences in the linear expansion coefficient between the optical element and a holding member without being affected by vibration. A further object of the present invention provides an exposure apparatus and device manufacturing method that efficiently manufactures a highly integrated device.

To solve the above problems, the present invention has the structure shown in FIGS. 1 to 13.

An optical element holding apparatus according to the present invention is an optical element holding apparatus (29) for holding an optical element (28). The optical element holding apparatus includes a holding member (45) which holds the optical element and which has a linear expansion coefficient differing from that of the optical element. A connection mechanism (100) connects the optical element and the holding member. The connection mechanism includes a buffer portion (88, 92, 97) having a linear expansion coefficient differing from the linear expansion coefficient of the holding member.

This invention includes a buffer portion having a linear expansion coefficient differing from the linear expansion coefficient of the holding member. This reduces distortion of the optical element that would be caused by a linear expansion coefficient difference between the optical element and the holding member. Accordingly, the optical capability of the optical element can be maintained in a satisfactory state.

Reference numerals used in the drawings have been added to facilitate description of the present invention. However, it should be understood that the present invention is not limited to the above embodiments and that the present invention is defined by the scope of the claims.

### BRIEF DESCRIPTION OF THE DRAWINGS

FIG. 1 is a schematic diagram showing an exposure apparatus according to a first embodiment;

FIG. 2 is a perspective view showing an optical element holding apparatus in the first embodiment;

FIG. 3 is an exploded perspective view showing a support member of FIG. 2;

FIG. 4 is a perspective view showing a seat block and a support block of FIG. 3;

FIG. 5 is a plan view showing the surrounding of the support member of FIG. 2;

FIG. 6 is a plan view showing a buffer member in an expanded state;

FIG. 7 is a cross-sectional view taken along line 7-7 in FIG. 5;

FIG. 8 is a cross-sectional view showing the surrounding of the support member for a frame body of FIG. 2;

FIG. 9 is a cross-sectional view showing an optical element holding apparatus according to a second embodiment of the present invention;

FIG. 10(a) is a plan view showing an optical element holding apparatus according to another embodiment in an initial state, and FIG. 10(b) is a plan view showing the optical element holding apparatus in a state in which the temperature has increased;

FIG. 11 is a cross-sectional view showing an optical element holding apparatus according to a further example:

FIG. 12 is a perspective view showing a modification of a base member;

FIG. 13 is a flowchart of an example for manufacturing a device; and

FIG. 14 is a detailed flowchart related to substrate processing for a semiconductor device.

### DETAILED DESCRIPTION OF THE PREFERRED EMBODIMENTS

Embodiments of the present invention will now be described with reference to the drawings.

### First Embodiment

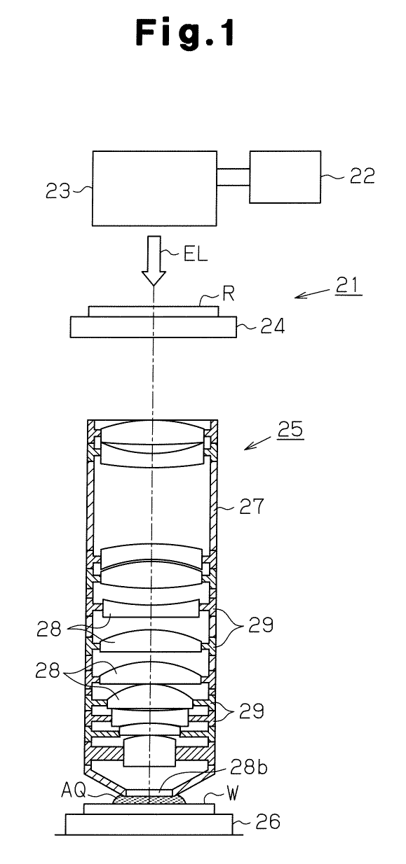

An exposure apparatus, an optical element holding apparatus, and a barrel according to the present invention may be embodied, for example, as an exposure apparatus for manufacturing a semiconductor device, an optical element holding apparatus for holding an optical element such as a lens, and a barrel for accommodating a projection optical system, as shown in FIGS. 1 to 8.

FIG. 1 is a schematic diagram showing an exposure apparatus 21. As shown in FIG. 1, the exposure apparatus 21 includes a light source 22, an illumination optical system 23, a reticle stage 24 for holding a reticle R (or a photomask), a projection optical system 25, and a wafer stage 26 for holding a wafer W.

The light source 22 includes, for example, an ArF excimer laser light source. The illumination optical system 23 includes various lenses, an aperture diaphragm, and the like (not shown). The various lenses include a relay lens, an optical integrator such as a fly's-eye lens or a rod lens, and a condenser lens. Exposure light EL emitted from the light source 22 is adjusted so as to evenly illuminate a pattern on the reticle R by passing through the illumination optical system 23.

The reticle stage 24 is arranged under the illumination optical system 23, that is, at an object surface side of the projection optical system 25, which will be described later, so that a mounting surface for the reticle R is substantially orthogonal to an optical axis direction of the projection optical system 25. The projection optical system 25 accommodates a plurality of optical elements (e.g., lens 28) in the barrel 27 by means of optical element holding apparatuses 29. The wafer stage 26 is arranged at an image plane side of the projection optical system 25 so that the mounting surface for the wafer W intersects the optical axis direction of the projection optical system 25. The projection optical system 25 reduces the image of the pattern on the reticle R illuminated by the exposure light EL by a predetermined reducing magnification and then projects and transfers the image onto the wafer W on the wafer stage 26.

The exposure apparatus of the present embodiment is an immersion exposure apparatus that exposes the wafer W through liquid AQ supplied between an objective lens (e.g., parallel flat plate) 28b (see FIG. 1), which is arranged closest to the wafer W in the barrel 27, and the wafer W. A gas supply mechanism (not shown) is arranged in the barrel 27, and a gas atmosphere is formed in the barrel 27 by inert gas (e.g., nitrogen gas) continuously supplied from the gas supply mechanism.

The structure of an optical element holding apparatus 29 will now be described in detail.

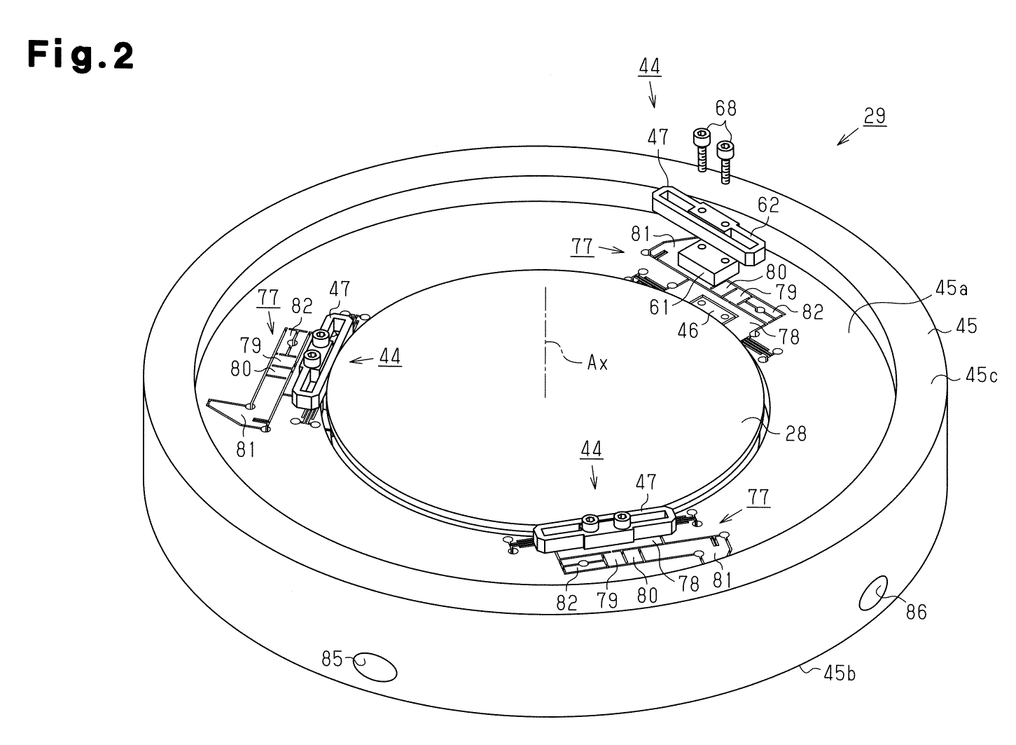

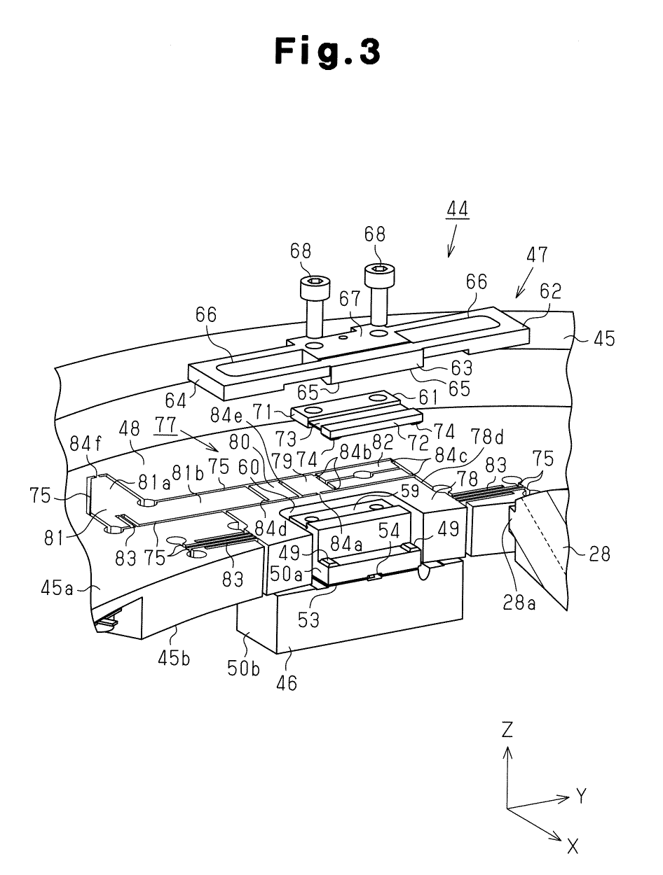

FIG. 2 is a cross-sectional view showing the optical element holding apparatus 29. In the example of FIG. 2, the lens 28 is made of glass material such as synthetic quartz, fluorite, and the like, and has a circular shape (see FIG. 3). A flange 28a is formed on a peripheral portion of the lens 28. The optical element holding apparatus 29 includes an annular frame body 45 formed by machining a metal material. The frame body 45 includes a first surface 45a, which is orthogonal to an optical axis AX of the lens 28, and a second surface 45b. A projection 45c projects from the frame body 45 in a direction parallel to the optical axis AX so as to surround the first surface 45a. The barrel 27 is formed by stacking a plurality of frame bodies 45 with the projection 45c of one frame body 45 contacting the second surface of another frame body 45. A support member 44 for holding the flange 28a of the lens 28 is fixed to the inner circumferential portion of the frame body 45 on the second surface 45b. The frame body 45 is one example of a holding member.

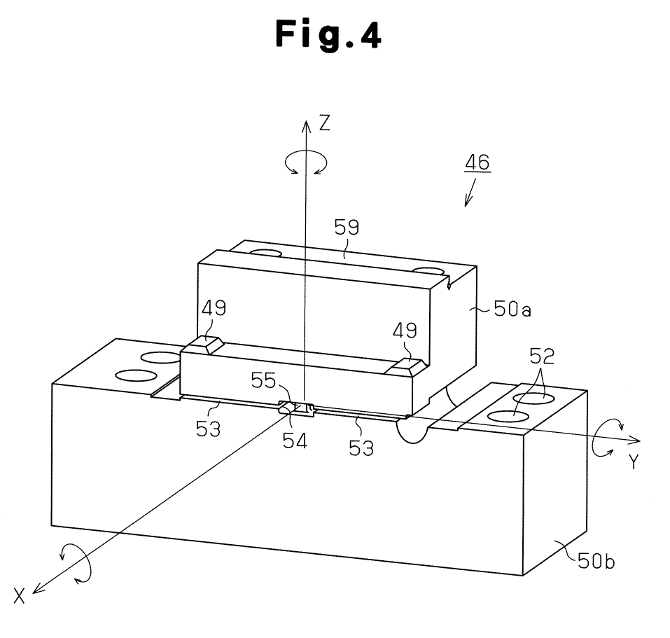

FIG. 3 is a perspective view illustrating the support member 44, and FIG. 4 is an enlarged view of a base member 46 included in the support member 44. The optical element holding apparatus 29 includes the frame body 45 and three support members 44, which are arranged at equal angular intervals on the frame body 45 and which hold the flange 28a of the lens 28.

The support member 44 includes a base member 46 and a clamp member 47. The frame body 45 is formed from an annular metal material. A cutout portion 60 for accommodating a seat block 50a, which will be described later, of the base member 46 is formed in the inner circumferential portion of the frame body 45.

The frame body 45 includes a displacement block 78 arranged near the cutout portion 60. The base member 46 is fixed to a second surface 45b of the displacement block 78. The base member 46 includes the seat block 50a, which has two seats 49 that engage one of the flange surfaces of the flange 28a of the lens 28, and a support block 50b, which adjusts the orientation of the seat block 50a.

The seat block 50a is arranged so that its longitudinal direction lies along the tangential direction of the inner circumference of the frame body 45. The seats 49 are formed at the two longitudinal ends of the seat block 50a. Further, the seats 49 are projections formed on the surface of the seat block 50a. In this specification, “a tangent of the inner circumference of the frame body 45” refers to a tangent of the inner circumference of the frame body 45 at the location of the cutout portion 60, or the support member 44.

A plurality of slits 53 and neck portions 55 are formed between the seat block 50a and the support block 50b. When the base member 46 is attached to the frame body 45, as shown in FIG. 4, the slits 53 extend through the frame body 45 in the radial direction (X-axis direction of FIG. 4). The neck portions 55 are milled out in the +X direction and −X direction from the base member 46.

Bolt holes 52, into which bolts (not shown) are inserted to fasten the support block 50b to the displacement block 78 of the frame body 45, are formed in the support block 50b at opposite sides of the seat block 50a in the longitudinal direction.

In the base member 46, which is formed as described above, the seat block 50a is supported in a rotatable manner about the axes in the X direction, Y direction, and Z direction relative to the support block 50b, which is fixed to the displacement block 78 of the frame body, by the neck portion 55. As a result, the orientation of the seat block 50a is adjusted along the surface of the flange 28a of the lens 28.

As shown in FIG. 3, the clamp member 47 includes a clamp body 62 and a pad member 61. The clamp body 62 includes a pressing block 63 and a supporter 64, which is formed integrally with the pressing block 63 to support the pressing block 63. On the two ends at the lower surface of the pressing block 63, two pressing surfaces 65 are defined facing toward the seats 49 of the seat block 50a.

The supporter 64 includes arm portions 66 and an attachment portion 67. The attachment portion 67 and the pressing block 63 are spaced apart by a predetermined distance. The arms 66 connect the two ends of the pressing block 63 to the attachment portion 67 and are elastically deformable. The clamp member 47 is fixed to the seat block 50a by fastening the attachment portion 67 to a fastening portion 59 of the seat block 50a with bolts 68 by means of the pad member 61.

The pad member 61 includes a clamped portion 71, which is held between the fastening portion 59 and the attachment portion 67, an action portion 72, which is arranged between the pressing surfaces 65 and the flange 28a of the lens 28, and an elastically deformable thin-plate portion 73, which has the form of a thin-plate and connects the clamped portion 71 and the action portion 72.

In the clamp member 47 formed in this manner, the arms 66 are elastically deformed when the bolts 68 are fastened. This applies pressure to the pressing surfaces 65 of the pressing block 63 towards the seat block 50a. The pressure acts on the flange 28a of the lens 28 via action surfaces 74 on the pad member 61. Thus, the flange 28a of the lens 28 is held by the seats 49 of the seat block 50a and the pressing surfaces 65 of the pressing block 63.

The support members 44 formed in this manner are arranged at three locations on the peripheral portion of the lens 28.

In the present embodiment, the optical element holding apparatuses 29 absorb differences in the thermal deformation amount between the lens 28 and the frame body 45.

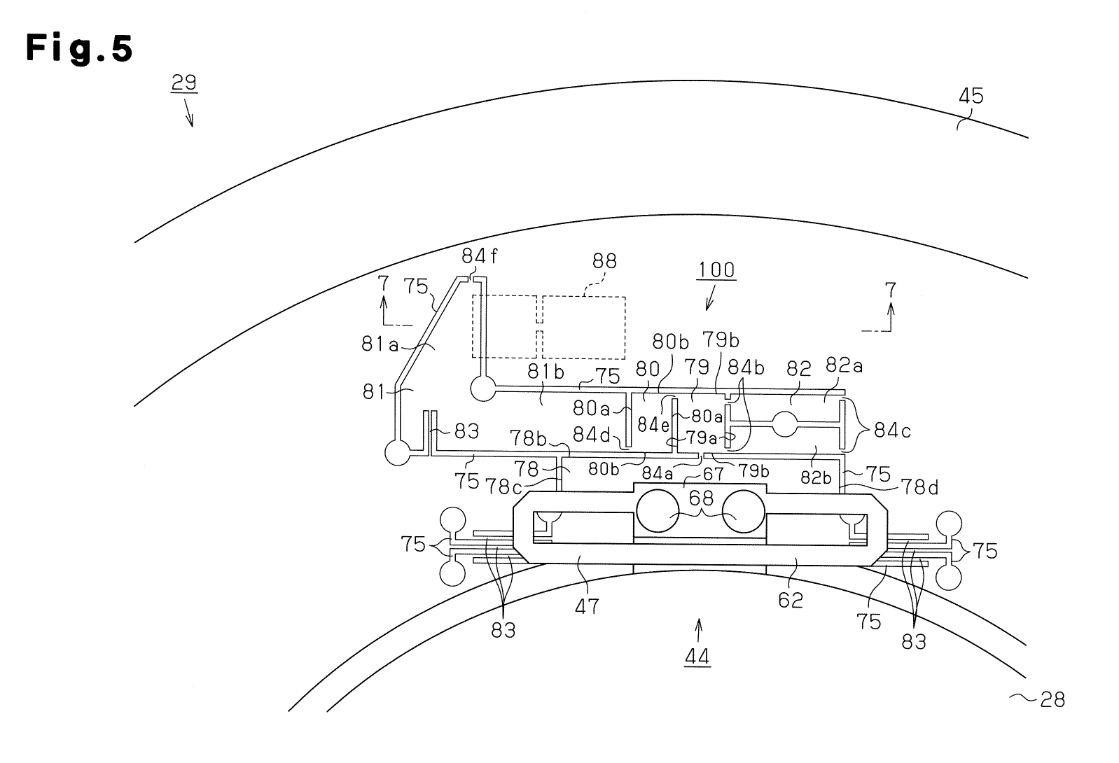

FIG. 5 is a plan view showing a portion of the frame body 45 where the support member 44 is attached. As shown in FIG. 5, a plurality of slits 75 are formed in correspondence with the cutout portion 60. The slits 75 connect the first surface 45a and second surface 45b of the frame body 45. Each of a plurality of pivots 84a to 84f is defined between adjacent two ends of the slits 75.

The pivots 84a to 84d are formed when forming the slits 75 in the frame body 45 by portions left in the frame body 45 between ends of the slits 75. Thus, the pivots 84a to 84f extend from the first surface 45a to the second surface 45b in the frame body 45.

The connection mechanism 100 of the present embodiment includes the support member 44, the displacement block 78, a spring mechanism (plate spring 83), a first connection block 79, a second connection block 80, a link member (rotation link block 81), a parallel link block 82, and the plurality of pivots 84a to 84f. The frame body 45 includes the displacement block 78, the plate spring 83, the first connection block 79, the second connection block 80, the rotation link block 81, the parallel link block 82, and the plurality of pivots 84a to 84f.

A second member 81b, which will be described later, of the rotation link block 81, the first connection block 79, the second connection block 80, and the parallel link block 82 are arranged parallel to the tangential direction of the inner circumference of the frame body 45. The displacement block 78 includes the cutout portion 60, and the support member 44 is fixed to the displacement block 78 in a state in which the seat block 50a is accommodated in the cutout portion 60.

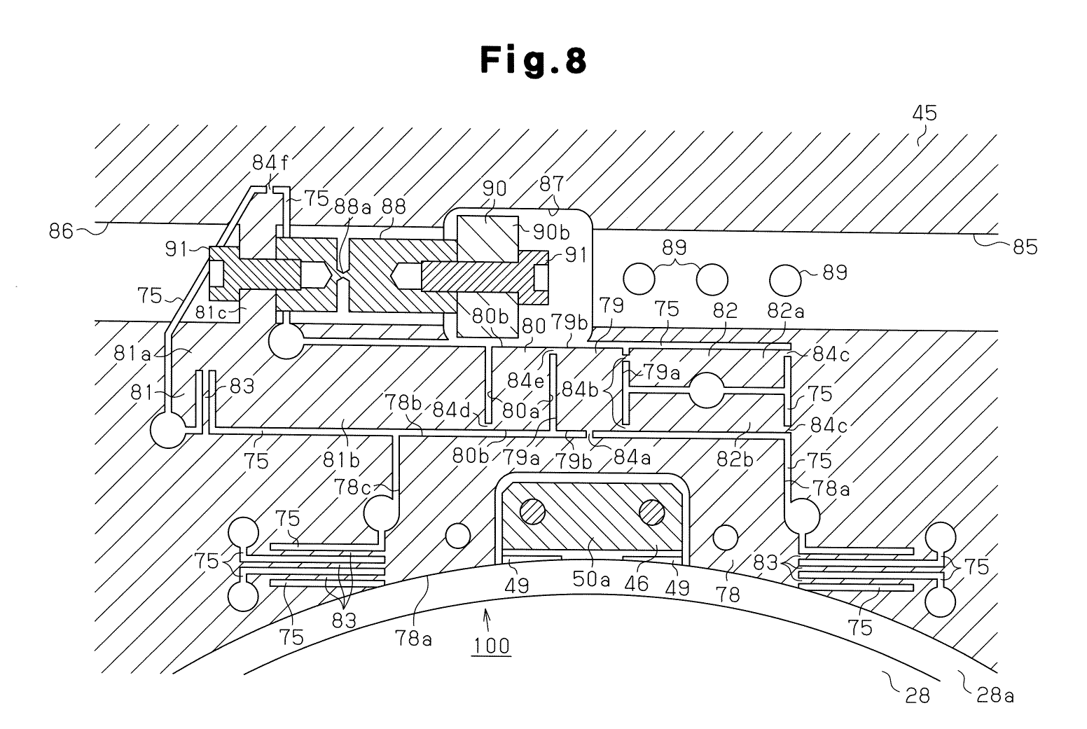

FIG. 8 is a cross-sectional view taken along a plane that is perpendicular to the optical axis of the lens 28 at a location near a support member 44 of the frame body 45. As shown in FIGS. 5 and 8, the displacement block 78 is rectangular and elongated in the tangential direction of the inner circumference of the frame body 45. The displacement block 78 includes an inner surface 78a formed toward the inner circumference of the frame body 45, an outer surface 78b formed toward the outer circumference of the frame body 45, and two side surfaces 78c and 78d, which are perpendicular to the inner surface 78a and the outer surface 78b. The first connection block 79 and the second connection block 80 respectively have two first side surfaces 79a and 80a, which are perpendicular to the tangential direction of the inner circumference of the frame body 45, and two side surfaces 79b and 80b, which are parallel to the tangential direction of the inner circumference of the frame body 45.

Three plate springs 83, which are thin plates, are connected to the two side surfaces 78c and 78d of the displacement block 78 in the inner circumferential portion of the frame body 45.

The three plate springs 83 are formed when forming slits 75 extending parallel to the tangential direction of the inner circumference of the frame body 45. The plate springs 83 enable the displacement block 78 to be displaced in the radial direction of the lens 28 relative to the frame body 45.

The displacement block 78 is connected to the first connection block 79 by the pivot 84a. The pivot 84a is located between the first connection block 79 and a generally middle portion of the outer surface of the displacement block 78 in the radial direction. Further, the pivot 84a is formed so as to extend from the first surface 45a toward the second surface 45b in the frame body 45.

One of the first side surfaces 79a of the first connection block 79 is connected to one side of the link block 82 by the pivots 84b. The other side of the parallel link block 82 is connected to the frame body 45 by the pivots 84c. More specifically, the parallel link block 82 includes two blocks 82a and 82b, which are thin-plates and defined by the slits 75 parallel to the tangential direction of the inner circumference of the frame body 45. One side of each of the blocks 82a and 82b is connected to the first connection block 79 by a pivot 84b, and the other side of each of the block 82a and 82b is connected to the frame body 45 by a pivot 84c. The parallel link block 82 restricts displacement of the first connection block 79 in the tangential direction of the lens 28 and permits translation of the first connection block 79 in the radial direction of the lens 28.

The other first side surface 79a of the first connection block 79 is connected to one of the side surfaces 80a of the second connection block 80 by the pivot 84e. The pivot 84e is formed on the other first side surface 79a of the first connection block 79 toward the outer circumference of the frame body 45.

The other first side surface 80a of the second connection block 80 is connected to the second member 81b of the rotation link block 81 by the pivot 84d. The pivot 84d is formed on the other first side surface 80a of the second connection block 80 toward the inner circumferential of the frame body 45.

When viewed from the first surface 45a of the frame body 45, the rotation link block 81 is generally L-shaped and includes a first member 81a, which extends in a direction perpendicular to the tangential direction of the inner circumference of the frame body 45, and a second member 81b, which extends in the tangential direction of the inner circumference of the frame body 45. That is, the first member 81a and the second member 81b are perpendicular to each other. The rotation link block 81 may be referred to as a right-angle link block.

In the first member 81a of the rotation link block 81, the side toward the outer circumference of the frame body 45 is connected to the frame body 45 by the pivot 84f. Further, the side of the first member 81a toward the inner circumference of the frame body 45 is connected to the frame body 45 by a plate spring 83. The plate spring 83 is defined between two parallel slits 75 along the extending direction of the first member 81a. As will be described later, when the buffer member 88 applies expansion-contraction force to the rotation link block 81, the plate spring 83 permits rotation of the first member 81a.

As shown in FIGS. 2 and 8, the frame body 45 includes a first bored portion 85 and a second bored portion 86, which are parallel to the tangential direction of the inner circumference of the frame body 45. The first bored portion 85 is formed by boring into the frame body 45 from the outer circumferential surface in a first direction. The second bored portion 86 is formed by boring into the frame body 45 from the outer circumferential surface in a direction opposite the first direction. The first bored portion 85 and the second bored portion 86 are formed in the frame body 45 toward the outer circumference from the first and second connection blocks 79 and 80 and the second member 81b of the rotation link block 81. The first member 81a of the rotation link block 81 is located between the first bored portion 85 and the second bored portion 86.

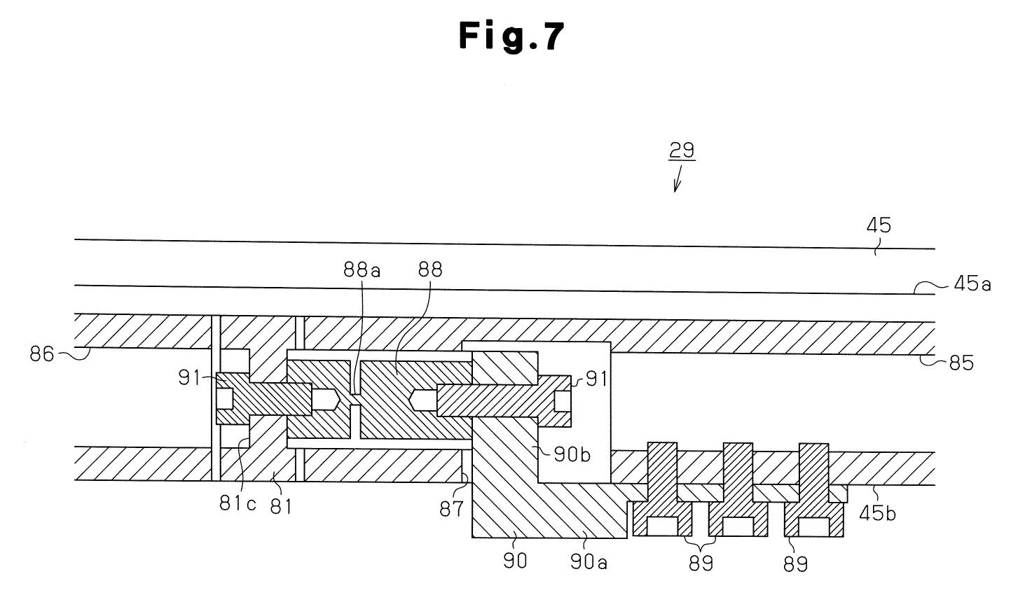

FIG. 7 is a cross-sectional view taken along line 7-7 in FIG. 5. When viewing the first member 81a from the second surface 45b of the frame body 45, as shown in FIG. 7, the first member 81a includes a wall portion 81c having parallel side surfaces. The wall portion 81c extends in a direction perpendicular to the tangential direction of the inner circumference of the frame body 45 (refer to FIG. 8).

The frame body 45 includes an opening 87 that extends into the first bored portion 85 from the second surface 45b of the frame body 45. The buffer member 88, which is formed from aluminum and generally cylindrical, is inserted into the first bored portion 85. The buffer member 88 contacts the wall portion 81c of the first member 81a of the rotation link block 81. A neck portion 88a is formed by milling a generally middle part of the buffer member 88. Bolts 91 fix the two ends of the buffer member 88 to the wall portion 81c and a fastener 90, respectively. The fastener 90 includes a plate 90a, which is fixed to the second surface 45b of the frame body 45 by bolts 89, and another plate 90b, which is inserted into the opening 87. The neck portion 88a formed at the generally middle part of the buffer member 88 functions as a joint enabling the buffer member 88 to at least bend and tilt. The neck portion 88a enables the surfaces of the buffer member 88 facing the wall portion 81c and the plate 90b to entirely contact the wall portion 81c and the plate 90b.

The operation of the optical element holding apparatus 29 will now be discussed.

In the optical element holding apparatus 29 of this embodiment, the frame body 45 is formed from stainless steel having a linear expansion coefficient of 10 ppm, and the lens 28 is formed from quartz glass having a linear expansion coefficient of 0.1 ppm.

FIG. 5 shows an initial state in which the lens 28 is attached to the frame body 45 by the support member 44 under a predetermined environmental temperature. When the linear expansion coefficient of the frame body 45 is greater than that of the lens 28, an increase in the environmental temperature from the initial state expands the frame body 45 outward in the radial direction of the lens 28. At the same time, the linear expansion coefficient of the lens 28 is smaller than that of the frame body 45. Thus, the expansion of the lens 28 is much smaller than the frame body 45.

If the lens 28 and the frame body 45 were to be strongly or rigidly connected to each other, the difference in the expansion amount of the frame body 45 and the lens 28 would apply stress to the lens 28 that outwardly pulls the circumference of the lens 28. The actual thermal expansion amount of the frame body 45 is small and only about 10 μm when the frame body 45 has a diameter of one meter and the temperature rises one degree Celsius.

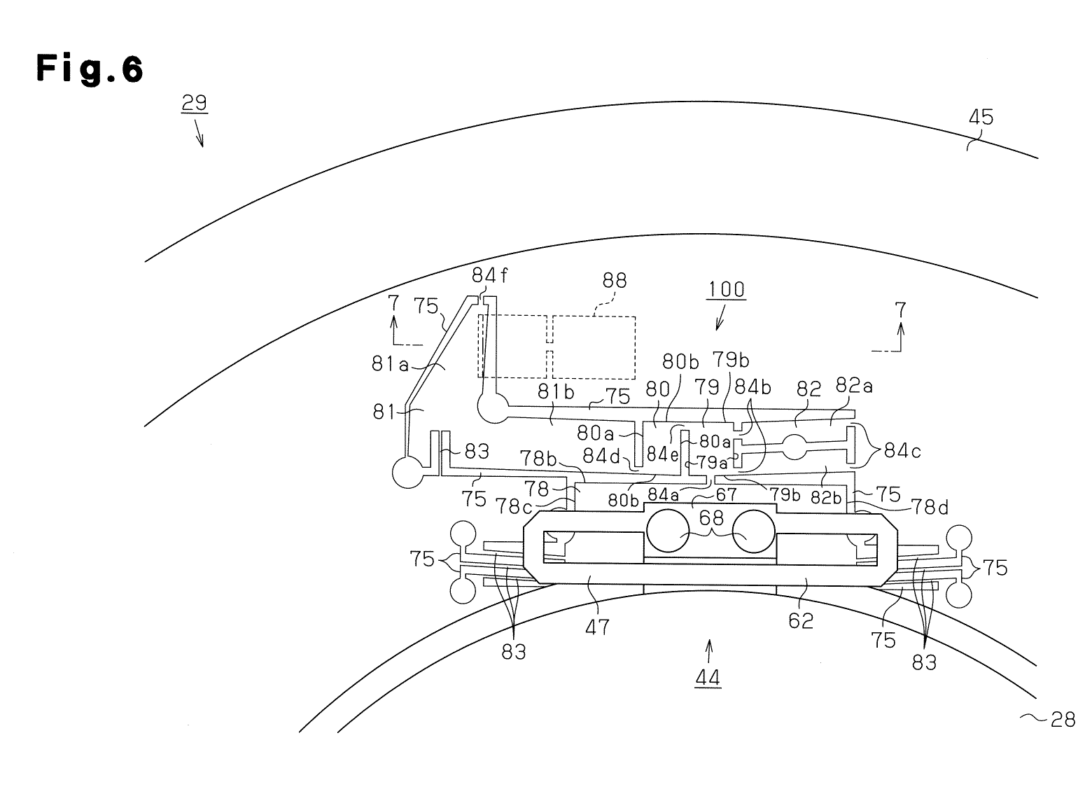

FIG. 6 is a diagram schematically showing a state in which a change in the environmental temperature expands the frame body 45 and flexes the buffer member 88 when the linear expansion coefficient of the frame body 45 is greater than the linear expansion coefficient of the lens 28 as in this embodiment. In the optical element holding apparatus 29 of the present embodiment, the connection mechanism 100, which includes the buffer member 88, connects the frame body 45 and the support member 44, which supports the lens 28. Further, the buffer member 88 is formed from a material that is more easily expanded by heat than the frame body 45. For example, the buffer member 88 is formed from aluminum having a linear expansion coefficient of 24 ppm. As shown in FIG. 6, when the environmental temperature rises in a state in which the optical element holding apparatus 29 is attached, the buffer member 88 expands in the axial direction from the state indicated by the double-dotted line in FIG. 6. The expansion of the buffer member 88 generates a force that forces the first member 81a of the rotation link block 81 toward the second bored portion 86. Thus, the central portion of the wall portion 81c that contacts the buffer member 88 acts as a point of force which receives the expansion-contraction force of the buffer member 88. To facilitate understanding, the thermal expansion amount of the buffer member 88 is shown in an exaggerated manner.

When the point of force receives the expansion-contraction force of the buffer member 88, the rotation link block 81 is rotated counterclockwise about the pivot 84f (fulcrum) that connects the first member 81a and the frame body 45 in the state of FIG. 6. The rotation moves the pivot 84d (action point), which connects the second member 81b and the second connection block 80, toward the inner circumference of the frame body 45. In this state, the plate spring 83 of the first member 81a extends in the same direction as the first member 81a and thus does not interfere with the rotation of the rotation cylinder block 81.

As the pivot 84d moves the pivot 84d toward the inner circumference of the frame body 45, the second connection block 80 rotates about the pivot 84e, which connects the second connection block 80 and the first connection block 79, and moves toward the inner circumference of the frame body 45. As a result, the first connection block 79, the rotation of which is restricted by the parallel link block 82, is moved toward the inner circumference of the frame body 45. The movement of the first connection block 79 is transmitted to the displacement block 78 via the pivot 84a, which connects the first connection block 79 and the displacement block 78. That is, the movement of the displacement block 78 also moves the support member 44 toward the lens 28.

In this manner, due to the difference in the linear expansion coefficient between the frame body 45 and the lens 28, the position of the lens 28 tends to change relative to the frame body 45. However, the connection mechanism 100, which includes the buffer member 88, absorbs the change. The buffer member 88 transmits the expansion-contraction force of the buffer member 88 to the displacement block 78, the plate springs 83, the first connection block 79, the second connection block 80, the rotation link block 81, and the parallel link block 82, which are connected to the frame body 45, with the plurality of pivots 84a to 84f. This increases rigidity between the blocks. In this state, the expansion amount of the buffer member 88 increases in proportion to the length of the first member 81a and second member 81b in the rotation cylinder block 81. In other words, as the length of the second member 81b increases relative to the length of the first member 81a, the expansion amount of the buffer member 88 is increased and transmitted to the second connection block 80. Thus, in the connection mechanism 100, the rotation link block 81, the first connection block 79, the second connection block 80, the parallel link block 82, and the pivots 84a to 84f function as an amplification mechanism for amplifying the expansion length of the buffer member 88.

Accordingly, in the optical element holding apparatus 29, the buffer member 88 expands as the temperature rises, and the expansion is amplified by the rotation link block 81. In other words, although the positional relationship between the lens 28 and the frame body 45 tends to change due to the linear expansion coefficient difference between the lens 28 and the frame body 45, the connection mechanism 100 absorbs such change. Further, the expansion of the buffer member 88 moves the support member 44 in a direction opposite the expansion direction of the frame body 45. Thus, virtually only the frame body 45 expands and the position of the lens 28 remains the same. Even when the support member 44 moves in the direction opposite the expansion direction of the frame body 45, stress is not applied to the lens 28. That is, the expansion-contraction force of the buffer member 88 is not transmitted to the lens 28 since the plate springs 83, which connect the neck portion 55 of the support member 44, the displacement block 78, and the frame body 45, are arranged between the lens 28 and the frame body 45. In other words, the expansion-contraction force of the buffer member 88 is absorbed by the connection mechanism 100 and thus not transmitted to the lens 28.

The expansion and contraction of the buffer member 88 and the operation of the rotation link block 81 are reversible. Thus, when the buffer member 88 contracts as the temperature falls, the contraction is transmitted to the displacement block 78 by the rotation link block 81 so that the displacement block 78 moves toward the outer circumference of the frame body 45. Thus, virtually only the frame body 45 contracts and the position of the lens 28 remains the same.

The present embodiment has the advantages described below.

(1) In the optical element holding apparatus 29, the support member 44 and frame body 45, which support the lens 28, are connected by the buffer member 88, which has a linear expansion coefficient differing from that of the frame body 45. Thus, even if a temperature change causes relative displacement of the lens 28 and the frame body 45, expansion or contraction of the buffer member 88 connects the frame body 45 and the connection mechanism 100 with high rigidity. This holds the lens 28 without producing unexpected distortion that would be caused by temperature changes while preventing changes in the relative positions of the frame body 45 and the lens 28 that would be caused by external vibrations transmitted to the frame body 45. Accordingly, the optical capability of the lens 28 remains in a satisfactory state regardless of vibrations or the temperature environment at where the exposure apparatus 21 is installed.

(2) In the optical element holding apparatus 29, the buffer member 88 is a generally cylindrical body having a linear expansion coefficient differing from that of the frame body 45. Thus, the simple addition of the buffer member 88 prevents vibrations and temperature changes from displacing the optical axis AX of the lens 28.

(3) The optical element holding apparatus 29 includes the connection mechanism 100 that amplifies the expansion and contraction of the buffer member 88. This enables the buffer member 88 to be reduced in size and suppresses enlargement of the optical element holding apparatus 29.

(4) In the optical element holding apparatus 29, part of the connection mechanism 100 is formed in the frame body 45. Thus, the expansion and contraction of the buffer member 88 can be amplified by using part of the frame body 45. This suppresses enlargement of the optical element holding apparatus 29 and suppresses an increase in the number of components.

(5) The optical element holding apparatus 29 has the rotation link block 81 that includes the first member 81a, which extends in a direction perpendicular to the tangential direction of the inner circumference of the frame body 45, and the second member 81b, which extends in a direction perpendicular to the direction in which the first member 81a extends. The first member 81a includes the pivots 84a to 84f, which function as fulcrums connected to the frame body 45, and points of force, which are located near the fulcrums and which receive expansion-contraction force produced by expansion and contraction of the buffer member 88. Further, the second member 81b includes action points transmitting the expansion-contraction force of the buffer member 88 toward the lens 28. Thus, the ratio of the lengths of the first member 81a and the second member 81b may be changed to easily change the amplification rate of the buffer member 88.

(6) The optical element holding apparatus 29 further includes the plate springs 83 that connect the rotation link block 81 to the frame body 45 while permitting transmission of the expansion-contraction force from the buffer member 88 to the second connection block 80. Thus, the supporting rigidity of the rotation link block 81 can be increased without interfering with the transmission of the expansion-contraction force in the connection mechanism 100.

(7) In the optical element holding apparatus 29, the buffer member 88 has a linear expansion coefficient that is greater than that of the frame body 45. This enables the small buffer member 88 to keep the amplification rate of the expansion-contraction force low in the connection mechanism 100.

(8) In the optical element holding apparatus 29, the frame body 45 has a linear expansion coefficient that is greater than that of the lens 28, and expansion and contraction of the buffer member 88 displaces the support member 44. Thus, when a temperature change occurs, the lens 28, which thermally expands less than the frame body 45, can be held without being affected by vibrations.

In the optical element holding apparatus 29, the displacement block 78, which is fixed to the support member 44, is connected to the frame body 45 by the plurality of plate springs 83. Thus, if the lens 28 and the frame body 45 are relatively displaced when attaching the lens 28 or when a temperature change occurs in the environment in which the exposure apparatus 21 is installed, the plate springs 83, which form a flexure structure, absorbs the relative displacement and avoids unexpected distortion of the lens 28. Further, the connection mechanism 100 includes the buffer member 88. This increases the rigidity of the connection mechanism 100 and reduces the influence of vibrations transmitted to the lens 28 through the frame body 45.

(10) In the barrel, the connection mechanism 100, which includes the buffer member 88, connects the lens 28 and the frame body 45. This suppresses the influence of relative displacement of the lens 28 and the frame body 45 caused by a temperature change. Further, the influence of vibrations transmitted to the lens 28 through the frame body 45 is suppressed. Thus, each of the lenses 28 in the barrel 27 can be maintained in a satisfactory surface state, and the optical capability of the projection optical system 25 can be maintained at a high level.

(11) In the exposure apparatus 21, the connection mechanism 100, which includes the buffer member 88, connects the lens 28 and the frame body 45. This suppresses the influence of relative displacement of the lens 28 and the frame body 45 caused by a temperature change. Further, the influence of vibrations transmitted to the lens 28 through the frame body 45 is suppressed. Thus, the optical capability of the projection optical system 25 can be maintained at a high level, and the exposure accuracy of the exposure apparatus 21 can be improved.

(12) In the exposure apparatus 21, the connection mechanism 100, which includes the buffer member 88, connects the lens 28 to the barrel 27 of the projection optical system 25, which forms a pattern on a wafer W. This suppresses the influence of relative displacement of the lens 28 and the frame body 45 caused by a temperature change. Further, the influence of vibrations transmitted to the lens 28 through the frame body 45 is suppressed. In the exposure apparatus 21, since the optical capability of the projection optical system 25 is improved, the pattern transfer accuracy can be further improved.

### Second Embodiment

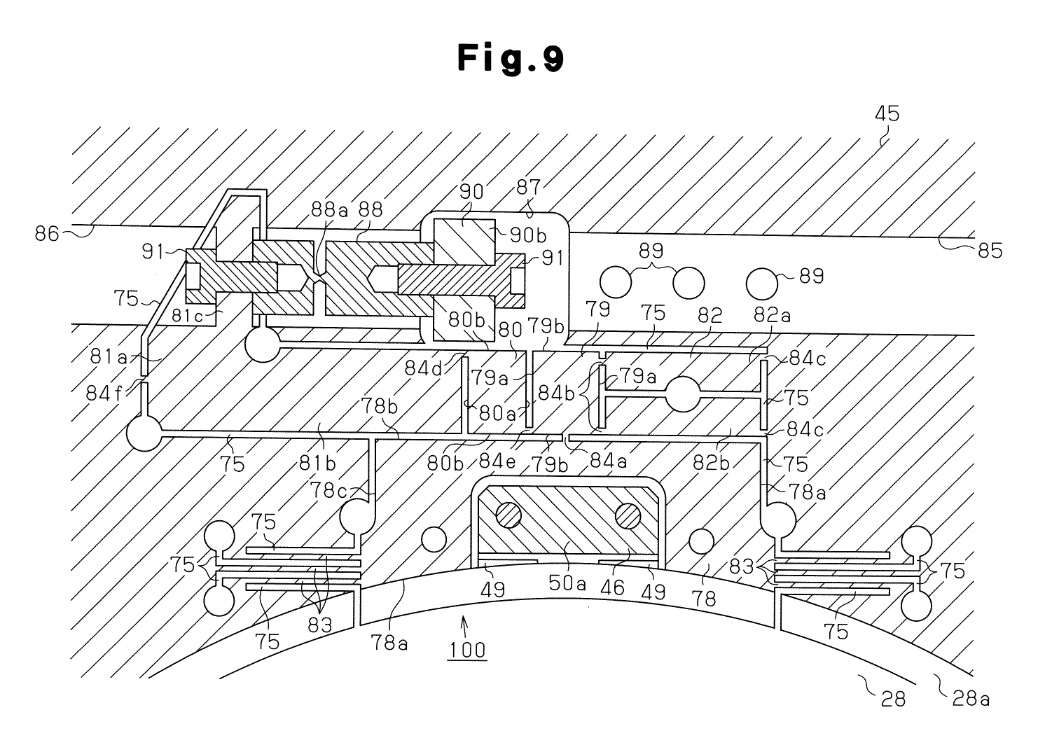

An optical element holding apparatus 29 of the second embodiment will now be described with reference to FIG. 9. The description will center on parts differing from the first embodiment.

As shown in FIG. 9, in the optical element holding apparatus 29 of the second embodiment, the position of the pivot 84f, which connects the rotation link block 81 and the frame body 45, differs from the first embodiment. The rotation link block 81 has an optimal structure for a combination in which, for example, the lens is formed from a glass material of fluorite (linear expansion coefficient being 23 ppm) and the frame body 45 is formed from stainless steel (linear expansion coefficient being 10 ppm), that is, a combination in which the liner expansion coefficient of the frame body 45 is smaller than the linear expansion coefficient of the lens 28.

As shown in FIG. 9, the pivot 84f, which connects the frame body 45 and the first member 81a of the rotation link block 81, is located on a side surface of the first member 81a, which extends perpendicular to the tangential direction of the inner circumference of the frame body 45. Further, the plate spring 83 that connects the first member 81a to the frame body 45 is eliminated. Additionally, the pivot 84d, which connects the first member 81a of the rotation link block 81 to the second connection block 80, is arranged toward the outer circumference of the frame body 45. The pivot 84e, which connects the first connection block 79 and the second connection block 80, is arranged toward the inner circumference of the frame body 45.

The rotation link block 81 of the embodiment operates as described below.

When the temperature rises from the temperature in the state in which the rotation link block 81 is attached to the optical element holding apparatus 29, the buffer member 88 expands in the axial direction from the state shown in FIG. 9. This forces the first member 81a of the rotation link block 81 toward the second bored portion 86. The wall portion 81c of the rotation link block 81 receives the expansion force of the buffer member 88. This rotates the rotation link block 81 counterclockwise about the pivot 84f (fulcrum) of the first member 81a to move the pivot 84d, which is located at the side closer to the second connection block 80 in the second member 81b, outward of the frame body 45. As a result, the first connection block 79, the rotation of which is restricted by the parallel link block 82, undergoes translation outward from the frame body 45. The translation of the first connection block 79 is transmitted to the displacement block 78, which is fixed to the support member 44 by the pivot 84a, and the displacement block 78 is moved outward the frame body 45. That is, the connection mechanism 100 of this embodiment operates in a direction that is completely opposite to the connection mechanism 100 of the first embodiment when the same expansion-contraction force is input by the buffer member 88.

Thus, in the optical element holding apparatus 29, the buffer member 88 expands as the temperature rises, and the lens 28 expands as if it virtually approaches the frame body 45. However, the support member 44, which supports the lens 28, moves outward in the radial direction of the lens to absorb the thermal expansion of the lens 28. This suppresses changes in the support state of the lens 28 and avoids unexpected compression of the lens 28.

Accordingly, in addition to advantages (1) to (7) and (9) to (12), the present embodiment has the advantages described below.

(13) In the optical element holding apparatus 29, the frame body 45 has a linear expansion coefficient that is smaller than the linear expansion coefficient of the lens 28. Further, expansion of the buffer member 88 moves the support member 44 toward the outer circumference of the frame body 45. Thus, when a temperature change occurs, the lens 28, the thermal expansion of which is greater than the frame body 45, can be held without being affected by vibrations.

The above embodiments may be modified to further embodiments as described below.

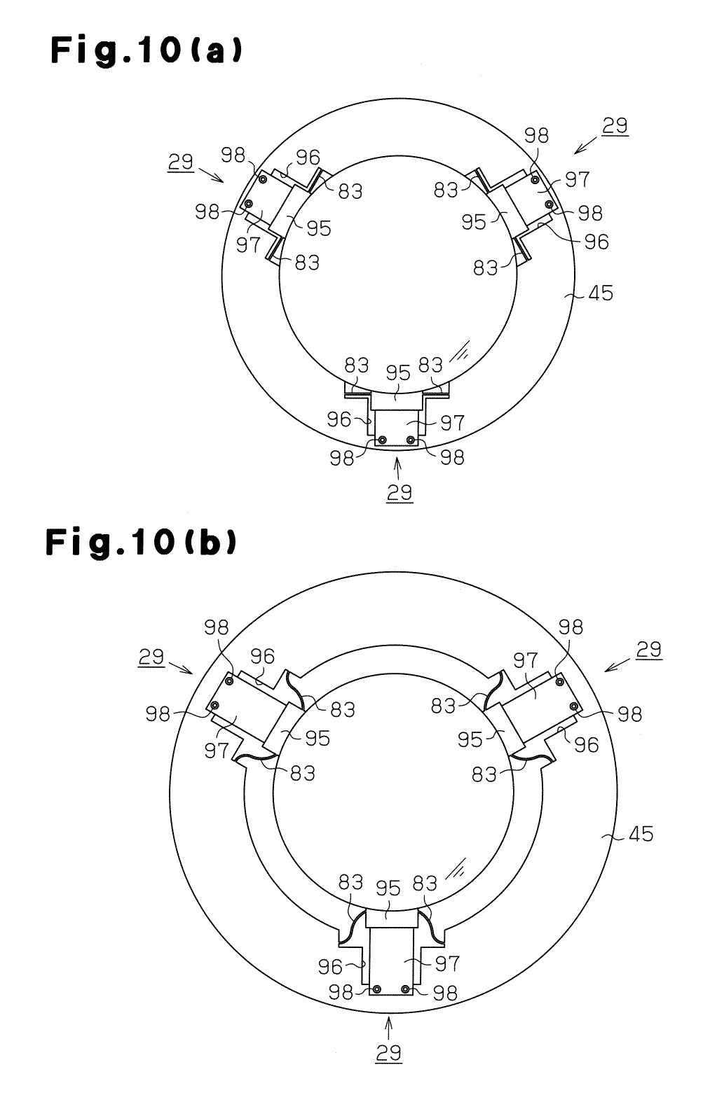

As shown in FIGS. 10(a) and 10(b), the optical element holding apparatus 29 may include a recess 96, which extends from the inner circumference to the outer circumference of the frame body 45. A buffer member 97 having a linear expansion coefficient that differs from that of the frame body 45 is arranged in the recess 96. One end of the buffer member 97 is fixed to the first surface 45a of the frame body 45 by bolts 98. The other end of the buffer member 97 is attached to a support member 95, which directly supports the circumferential portion of a lens 28. Plate springs 83, which are arranged in the tangential direction of the inner circumference of the frame body 45, connect the two side surfaces of the support member 85 to the inner circumferential portion of the frame body 45. In this structure, the buffer member 97 also functions as a connection mechanism connecting the support member 95, which supports the lens 28, and the frame body 45.

In the optical element holding apparatus 29, when the linear expansion coefficient of the frame body 45 is greater than that of the lens, the buffer member 97 is formed from a material having a greater linear expansion coefficient than the frame body 45. FIG. 10(a) shows an initial state in which the lens 28 is attached to the frame body 45. When the temperature rises from this initial state, the frame body 45 expands more than the lens 28. In the example shown in FIG. 10(b), the frame body 45 and the buffer member 97 virtually expand greatly and the displacement of the lens 28 is subtle. In FIG. 10(b), to facilitate understanding, the expansion of the frame body 45 and the buffer member 97 is shown in an exaggerated manner.

In such a structure, the support member 95 is supported from two sides with respect to the frame body 45. Thus, the lens can be stably held. Further, the plate springs 83 function as a flexure mechanism that absorbs the relative displacement of the lens 28 and the frame body 45 with the plate springs 83.

In this embodiment, the buffer member 97 may be fixed to the outer circumferential surface of the frame body 45 by a connection plate 93.

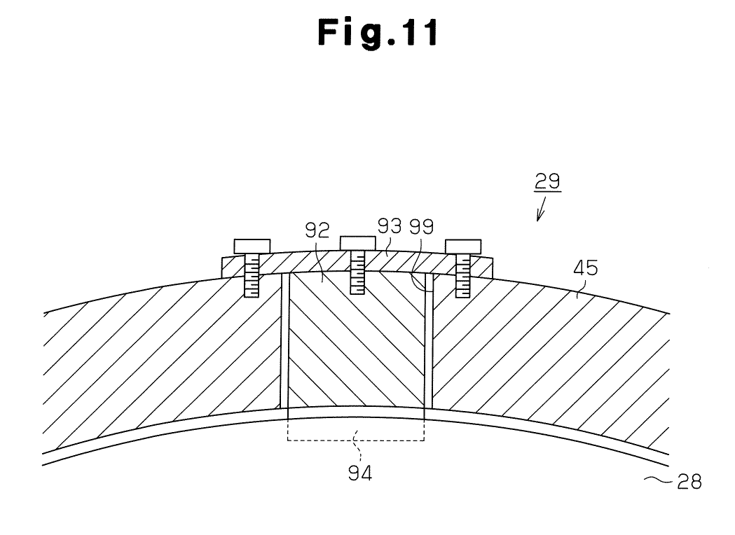

As another embodiment, as shown in FIG. 11, an optical element holding apparatus 29 has an opening 99, which extends through the frame body 45, in the radial direction of the frame body 45. A buffer member 92, which has a linear expansion coefficient differing from that of the frame body 45, is inserted into the opening 99. One end of the buffer member 92 is fixed to the outer circumferential surface of the frame body 45 by a connection plate 93. The other end of the buffer member 92 includes a lens seat 94, which directly supports the circumferential portion of a lens 28. In this structure, the buffer member 92 functions as a support member for supporting the lens 28 and a connection mechanism for connecting the support member and the frame body 45. This structure significantly simplifies the structure of the optical element holding apparatus 29.

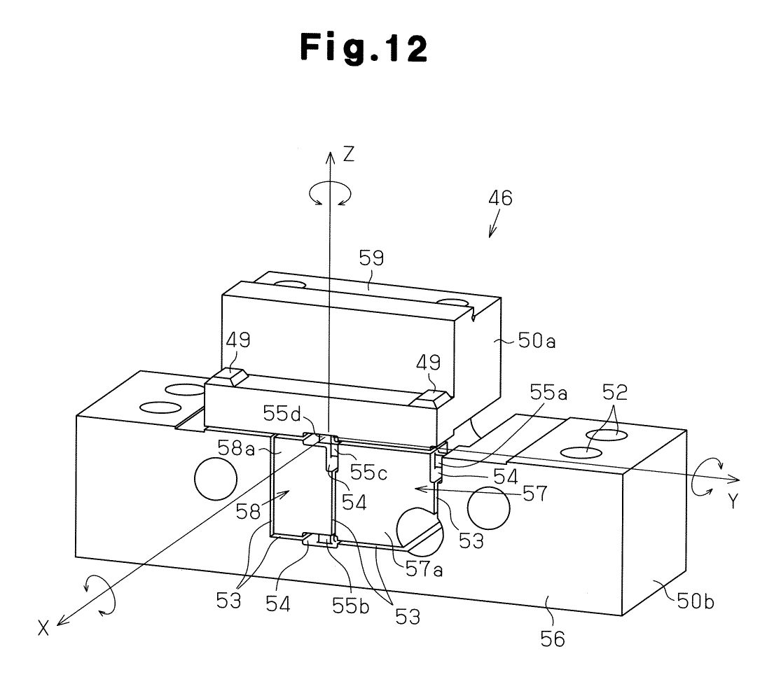

The base member 46 of FIG. 4 may be replaced by the base member 46 shown in FIG. 12.

In the base member 46 of FIG. 12, the support block 50b includes slits 53, which define a base portion 56, a first block 57a, and a second block 58a. The base portion 56 is fixed to the frame body 45. A first neck portion 55a connects the base portion 56 and the first block 57a. A second neck portion 55b connects the base portion 56 and the second block 58a. A third neck portion 55c connects the first block 57a and the second block 58a. A fourth neck portion 55d connects the second block 58a and the seat block 50a. The neck portions 55a to 55d each have the shape of a quadrangular prism with a cross-sectional area that is much smaller than those of the first block 57a, the second block 58a, the base portion 56, and the seat block 50a.

Among the neck portions 55a to 55d, the second and fourth neck portions 55b and 55d are arranged along a line extending through the middle of the two seats 49 of the seat block 50a. The line is perpendicular to a line connecting the two seats 49 and is parallel to the Z axis. The first and third neck portions 55a and 55c are arranged along a line parallel to the line connecting the two seats 49. Further, the third neck portion 55c is arranged near the fourth neck portion 55d.

The first block 57a is fixed to the second block 58a and the base portion 56 by the first neck portion 55a and the third neck portion 55c. The first neck portion 55a and the third neck portion 55c hold the first block 57a so as to enable rotation about the Y direction (tangential direction of the lens 28) while restricting movement in the Y direction. The first block 57a, the first neck portion 55a, and the third neck portion 55c form a tangential direction movement restriction link 57, which restricts movement in the tangential direction of the lens 28.

The second neck portion 55b and the fourth neck portion 55d fix the second block 58a to the seat block 50a and the base portion 56. The second neck portion 55b and the fourth neck portion 55d hold the second block 58a so as to enable rotation about the Z direction (direction parallel to the optical axis of the lens 28) while restricting movement in the Z direction. The second block 58a, the second neck portion 55b, and the fourth neck portion 55c form an optical axis direction movement restriction link 58, which restricts movement in a direction parallel to the optical axis of the lens 28.

The restriction direction of the tangential direction movement restriction link 57 and the restriction direction of the optical axis direction movement restriction link 58 are perpendicular to each other. In other words, the rotation axis of the tangential direction movement restriction link 57 and the rotation axis of the optical axis direction movement restriction link 58 are perpendicular to each other.

The fourth neck portion 55d connects the seat block 50a to the support block 50b. That is, the seat block 50a is supported on the base portion 56 by a pair of link mechanisms including the tangential direction movement restriction link 57 and the optical axis direction movement restriction link 58.

In each embodiment, the frame body 45 is formed from stainless steel. However, the frame body 45 may be formed from other material, such as a light material, like aluminum, or brass that has undergone, for example, a washing process that prevents the production of impurities or a coating process.

In each embodiment, the buffer members 88, 92, and 97 are formed from aluminum. However, the buffer members 88, 92, and 97 may be formed from other materials, such as brass.

The optical element holding apparatus 29 of each embodiment may be a holding apparatus that holds the lens 28 in a kinematic manner or with six degrees of freedom, five degrees of freedom, or three degrees of freedom.

In each embodiment, the support members 44 and 95 are arranged at equal intervals on the frame body 45. However, the support members 44 and 95 may be arranged at unequal intervals.

In each embodiment, the atmosphere fluid in the barrel 27 is nitrogen gas. However, the atmosphere fluid may be air or inert gas such as helium, argon, krypton, radon, neon, xenon, and the like.

In each embodiment, an optical element holding apparatus according to the present invention is embodied in the optical element holding apparatus 29 for holding the lens 28. An optical element holding apparatus according to the present invention may also be embodied in an optical element holding apparatus for holding other optical elements, such as a mirror, half mirror, parallel flat plate, prism, prism mirror, rod lens, fly's-eye lens, phase difference plate, throttle plate, or the like.

The optical element holding apparatus is not limited to a holding structure for a lens 28 horizontally arranged in a projection optical system 25 of an exposure apparatus 21 as in the above embodiments. For example, the optical element holding apparatus may be embodied in a holding structure for an optical element in the illumination optical system 23 of the exposure apparatus 21 or in a holding structure for an optical element, which has an optical axis intersecting the gravitational direction, of a reflection-refraction type projection optical system, or a so-called vertical type holding structure. Furthermore, the optical element holding apparatus may be embodied in a holding structure for an optical element in an optical system of other optical machines, such as a microscope, an interferometer, or the like.

The optical element holding apparatus 29 in each embodiment has high support rigidity in the radial direction of an optical element and effectively suppresses the transmission of vibrations. Thus, the optical element holding apparatus 29 is optimal for use as a vertical type holding structure that is apt to being affected by vibrations in the radial direction of an optical element.

Water (pure water), a fluorine liquid, and decalin (C₁₀H₁₈) may be used as the liquid AQ in the immersion exposure apparatus of the present embodiment.

Application of the optical element holding apparatus is not limited to an immersion exposure apparatus. The optical element holding apparatus is also applicable to an exposure apparatus having a predetermined gas (e.g., air or inert gas) filled between a projection optical system and a wafer. The optical element holding apparatus is also applicable to an optical system, such as an optical system for a contact exposure apparatus, which arranges a mask and a substrate in close contact with each other when exposing a pattern of the mask without using a projection optical system, and a proximity exposure apparatus, which arranges a mask and a substrate proximal to each other when exposing a pattern of the mask. The projection optical system is not limited to an all-refraction type and may be a reflection-refraction type or all-reflection type system.

Furthermore, the exposure apparatus of the present invention is not limited to an exposure apparatus of a reduction exposure type and may be an equal magnification exposure type or enlargement exposure type exposure apparatus.

The present invention is applicable not only to an exposure apparatus that manufactures a micro-device such as a semiconductor device but also to an exposure apparatus for transferring a circuit pattern from a mother reticle to a glass substrate, a silicon wafer, or the like to manufacture a reticle or a mask used in a light exposure apparatus, an EUV exposure apparatus, an X-ray exposure apparatus, an electron beam exposure apparatus, or the like. A transmissive reticle is generally used in an exposure apparatus using DUV (Deep Ultra Violet), VUV (Vacuum Ultra Violet) light, or the like. Quartz glass, quartz glass doped with fluorine, fluorite, magnesium fluoride, crystal, or the like may be used as the reticle substrate. In a proximity type X-ray exposure apparatus, an electron beam exposure apparatus, or the like, a transmissive mask (stencil mask, membrane mask) is used and silicon wafer or the like is used as the mask substrate.

Obviously, the present invention is also applicable not only to an exposure apparatus for manufacturing a semiconductor device but also to an exposure apparatus for manufacturing a display including a liquid crystal display device (LCD) or the like and transferring a device pattern onto a glass substrate, an exposure apparatus for manufacturing a thin-film magnetic head or the like and transferring a device pattern onto a ceramic wafer or the like, and an exposure apparatus for manufacturing an imaging element such as a CCD or the like.

Furthermore, the present invention may be applied to a scanning stepper that transfers a pattern of a mask onto a substrate in a state in which the mask and the substrate are relatively moved and sequentially step-moves the substrate, and a step-and-repeat type stepper that transfers a pattern of a mask onto a substrate in a state in which the mask and the substrate are still and sequentially step-moves the substrate.

The light source of the exposure apparatus may be a g-line (436 nm), an i-line (365 nm), a KrF excimer laser (248 nm), an F₂ laser (157 nm), a Kr₂ laser (146 nm), an Ar₂ laser (126 nm), or the like. The harmonic wave in which single wavelength laser light of infrared region or visible region oscillated from the DFB semiconductor laser or the fiber laser is amplified with a fiber amplifier doped with erbium (or both erbium and ytterbium), and wavelength converted to an ultraviolet light using a non-linear optical crystal may be used.

The exposure apparatus 21 of each embodiment is manufactured, for example, in the following manner.

First, at least some of the optical elements, such as the plurality of lenses 28 or mirrors, forming the illumination optical system 23 and the projection optical system 25 are held via the optical element holding apparatuses 29 of the present embodiment. The illumination optical system 23 and the projection optical system 25 are arranged in the main body of the exposure apparatus 21 and then optical adjustments are performed. The wafer stage 26 (including the reticle stage 24 for a scan type exposure apparatus), which is formed by many mechanical components, is attached to the main body of the exposure apparatus 21. Then, wires are connected. After connecting a gas supply pipe for supplying gas into the optical path of the exposure light EL, general adjustments (electrical adjustment, operation check, or the like) are performed.

Each component is assembled to the optical element holding apparatus 29 after removing processing oil and impurities such as metal material by performing ultrasonic cleaning or the like. The manufacturing of the exposure apparatus 21 is preferably performed in a clean room in which the temperature, humidity, and pressure are controlled, and in which the cleanness is adjusted.

In each embodiment, fluorite, synthetic quartz, or the like can be used as the glass material. However, the optical element holding apparatus of the above embodiments may also be applied when crystals such as lithium fluoride, magnesium fluoride, strontium fluoride, lithium-calcium-aluminum-fluoride, lithium-strontium-aluminum-fluoride, or the like; glass fluoride including zirconium-barium-lanthanum-aluminum; and modified quartz such as quartz glass doped with fluorine, quartz glass doped with hydrogen in addition to fluorine, quartz glass containing a OH group, quartz glass containing a OH group in addition to fluorine can be used.

An embodiment of a manufacturing method for a device in which the exposure apparatus 21 described above is used in a lithography process will now be described.

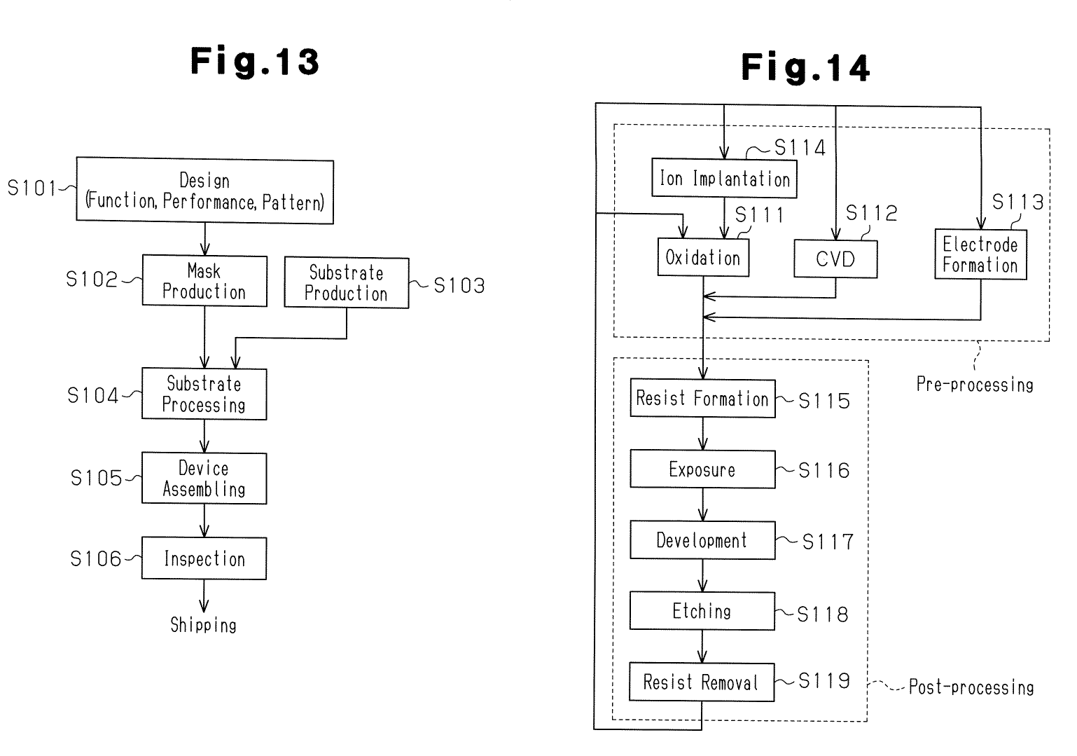

FIG. 13 is a flowchart illustrating an example for manufacturing a device (semiconductor device such as an IC and LSI, liquid crystal display device, imaging device (CCD or the like), thin-film magnetic head, micro-machine, or the like). As shown in FIG. 13, first, in step S101 (design step), a function/performance design (e.g., circuit design etc. of semiconductor device) for the device (micro-device) is performed, and a pattern design for realizing the function of the device is performed. Subsequently, in step S102 (mask production step), a mask (reticle R etc.) that forms the designed circuit pattern is produced. In step S103 (substrate production step), a substrate (wafer W when silicon material is used) is produced using material such as silicon, glass plate, or the like.

In step S104 (substrate processing step), the mask and substrate prepared in steps S101 to S103 are used to form an actual circuit or the like on the substrate through a lithography technique, as will be described later. In step S105 (device assembling step), device assembly is performed using the substrate processed in step S104. Step S105 includes the necessary processes, such as dicing, bonding, and packaging (chip insertion or the like).

Finally, in step S106 (inspection step), inspections such as an operation check test, durability test, or the like are conducted on the device manufactured in step S105. Upon completion of such processes, the device is completed and then shipped out of the factory.

FIG. 14 is a flowchart showing in detail one example of the procedures performed in step S104 of FIG. 13 in the case of a semiconductor device. As shown in FIG. 14, in step Sill (oxidation step), the surface of the wafer W is oxidized. In step S112 (CVD step), an insulating film is formed on the surface of the wafer W. In step S113 (electrode formation step), an electrode is formed on the wafer W by performing vapor deposition. In step S114 (ion implantation step), ions are implanted into the wafer W. Steps S111 to S114 described above are pre-processing operations for each stage of wafer processing and are selected and performed in accordance with the processing necessary in each stage.

In each wafer processing stage, when the above-described pre-processing ends, post-processing is performed as described below. In the post-processing, first in step S115 (resist formation step), a photosensitive agent is applied to the wafer W. Subsequently, in step S116 (exposure step), the circuit pattern of a mask (reticle R) is transferred onto the wafer W by the lithography system (exposure apparatus 21), which is described above. In step S117 (development step), the exposed wafer W is developed, and in step S118 (etching step), exposed parts where there is no remaining resist are etched and removed. In step S119 (resist removal step), unnecessary resist subsequent to etching is removed.

Repetition of the pre-processing and post-processing forms many circuit patterns on the wafer W.

In the above-described device manufacturing method of the present embodiment, the use of the exposure apparatus 21 in the exposure process (step S116) enables the resolution to be increased due to the exposure light EL of the vacuum ultraviolet band. Further, the exposure light amount can be controlled with high accuracy. As a result, devices with a high degree of integration and having a minimum line width of about 0.1 μm are manufactured at a satisfactory yield.

The invention is not limited to the foregoing embodiments but various changes and modifications of its components may be made without departing from the scope of the present invention. Also, the components disclosed in the embodiments may be assembled in any combination for embodying the present invention. For example, some of the components may be omitted from all of the components disclosed in the embodiments. Further, components from different embodiments may be appropriately combined.

1. An optical element holding apparatus that holds an optical element, the optical element holding apparatus comprising:
a holding member which holds the optical element and which has a linear expansion coefficient differing from that of the optical element; and
a connection mechanism which connects the optical element with the holding member;
wherein the connection mechanism includes a buffer portion having a linear expansion coefficient differing from the linear expansion coefficient of the holding member.

2. The optical element holding apparatus according to claim 1, wherein the linear expansion coefficient of the optical element, the linear expansion coefficient of the holding member, and the linear expansion coefficient of the buffer portion differ from one another.

3. The optical element holding apparatus according to claim 1, wherein the linear expansion coefficient of the buffer portion is greater than the linear expansion coefficient of the holding member.

4. The optical element holding apparatus according to claim 3, wherein the linear expansion coefficient of the holding member is greater than the linear expansion coefficient of the optical element.

5. The optical element holding apparatus according to claim 1, wherein the linear expansion coefficient of the buffer portion is less than the linear expansion coefficient of the holding member.

6. The optical element holding apparatus according to claim 5, wherein the linear expansion coefficient of the holding member is less than the linear expansion coefficient of the optical element.

7. The optical element holding apparatus according to claim 1, wherein the buffer portion is displaced in accordance with a change in relative positions of the optical element and the holding member caused by a linear expansion coefficient difference between the optical element and the holding member.

8. The optical element holding apparatus according to claim 7, wherein at least a part of the buffer portion expands and contracts in accordance with the change in relative positions of the optical element and the holding member.

9. The optical element holding apparatus according to claim 1, wherein a part of the connection mechanism is formed in the holding member.

10. The optical element holding apparatus according to claim 1, wherein the connection mechanism includes an amplification mechanism that amplifies expansion and contraction of the buffer portion.

11. The optical element holding apparatus according to claim 10, wherein:
the amplification mechanism includes a link member having a first member, which extends in a first direction, and a second member, which extends in a direction perpendicular to the first direction;
the first member of the link member includes a fulcrum, which is connected to the holding member, and a point of force, which receives expansion-contraction force from the buffer portion; and
the second member of the link member includes an action point, which transmits the expansion-contraction force from the buffer portion toward the optical element.

12. The optical element holding apparatus according to claim 11, further comprising:
a spring mechanism which connects the link member to the holding member and which permits transmission of the expansion-contraction force from the point of force to the action point.

13. The optical element holding apparatus according to claim 1, wherein the connection mechanism which supports the optical element and which absorbs relative displacement of the optical element and the holding member caused by a difference between the linear expansion coefficient of the optical element and the linear expansion coefficient of the holding member.

14. The optical element holding apparatus according to claim 13, wherein the connection mechanism includes a support member which supports the optical element, and when the linear expansion coefficient of the holding member is greater than the linear expansion coefficient of the optical element, the connection mechanism moves the support member toward the optical element due to the action of the buffer portion.

15. The optical element holding apparatus according to claim 13, wherein the connection mechanism includes a support member which supports the optical element, and when the linear expansion coefficient of the holding member is less than the linear expansion coefficient of the optical element, the connection mechanism moves the support member toward the holding member due to the action of the buffer portion.

16. A barrel that holds a plurality of optical elements, wherein at least one of the optical elements is held via the optical element holding apparatus according to claim 1.

17. An exposure apparatus that exposes a substrate with exposure light through a plurality of optical elements, wherein at least one of the optical elements is held via the optical element holding apparatus according to claim 1.

18. The exposure apparatus according to claim 17, wherein the plurality of optical elements form an optical system that forms a pattern on the substrate.

19. A device manufacturing method, comprising:
a lithography process, wherein the lithography process uses the exposure apparatus according to claim 17.
